(19) United States
(12) Patent Application Publication
(10) Pub. No.: US 2012/0096295 A1
(43) Pub. Date: Apr. 19, 2012

(54) METHOD AND APPARATUS FOR DYNAMIC POWER CONTROL OF CACHE MEMORY

(76) Inventor: Robert Krick, Longmont, CO (US)

(21) Appl. No.: 12/906,472

(22) Filed: Oct. 18, 2010

(51) Int. Cl. G06F 1/32

(52) U.S. Cl. 713/324

(57) ABSTRACT

The present invention provides a method and apparatus for dynamic power control of a cache memory. One embodiment of the method includes disabling a subset of lines in the cache memory to reduce power consumption during operation of the cache memory.

### BACKGROUND OF THE INVENTION

1. Field of the Invention

This invention relates generally to processor-based systems, and, more particularly, to dynamic power control of cache memory.

2. Description of the Related Art

Many processing devices utilize caches to reduce the average time required to access information stored in a memory. A cache is a smaller and faster memory that stores copies of instructions and/or data that are expected to be used relatively frequently. For example, processors such as central processing units (CPUs) graphical processing units (GPU), accelerated processing units (APU), and the like are generally associated with a cache or a hierarchy of cache memory elements. Instructions or data that are expected to be used by the CPU are moved from (relatively large and slow) main memory into the cache. When the CPU needs to read or write a location in the main memory, it first checks to see whether the desired memory location is included in the cache memory. If this location is included in the cache (a cache hit), then the CPU can perform the read or write operation on the copy in the cache memory location. If this location is not included in the cache (a cache miss), then the CPU needs to access the information stored in the main memory and, in some cases, the information can be copied from the main memory and added to the cache. Proper configuration and operation of the cache can reduce the average latency of memory accesses below the latency of the main memory to a value close to the value of the cache memory.

One widely used architecture for a CPU cache memory is a hierarchical cache that divides the cache into two levels known as the L1 cache and the L2 cache. The L1 cache is typically a smaller and faster memory than the L2 cache, which is smaller and faster than the main memory. The CPU first attempts to locate needed memory locations in the L1 cache and then proceeds to look successively in the L2 cache and the main memory when it is unable to find the memory location in the cache. The L1 cache can be further subdivided into separate L1 caches for storing instructions (L1-I) and data (L1-D). The L1-I cache can be placed near entities that require more frequent access to instructions than data, whereas the L1-D can be placed closer to entities that require more frequent access to data than instructions. The L2 cache is typically associated with both the L1-I and L1-D caches and can store copies of instructions or data that are retrieved from the main memory. Frequently used instructions are copied from the L2 cache into the L1-I cache and frequently used data can be copied from the L2 cache into the L1-D cache. With this configuration, the L2 cache is referred to as a unified cache.

Although caches generally improve the overall performance of the processor system, there are many circumstances in which a cache provides little or no benefit. For example, during a block copy of one region of memory to another region of memory, the processor performs a sequence of read operations from one location followed by a sequence of load or store operations to the new location. The copied information is therefore read out of the main memory once and then stored once, so caching the information would provide little or no benefit because the block copy operation does not reference the information again after it is stored in the new location. For another example, many floating-point operations use algorithms that perform an operation on information in a memory location and then immediately write out the results to a different (or in some cases the same) location. These algorithms may not benefit from caching because they don't repeatedly reference the same memory location. Generally speaking, caching exploits temporal and/or spatial locality of references to memory locations. Operations that do not repeatedly reference the same location (temporal locality) or repeatedly reference nearby locations (spatial locality) do not derive as much (or any) benefit from caching. To the contrary, the overhead associated with operating the caches may reduce the performance of the system in some cases.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for dynamic power control of a cache memory. One embodiment of the method includes disabling a subset of lines in the cache memory to reduce power consumption during operation of the cache memory.

In another embodiment, an apparatus is provided for dynamic power control of a cache memory. One embodiment of the apparatus includes a cache controller configured to disable a subset of lines in a cache memory to reduce power consumption during operation of the cache memory.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a semiconductor device that may be formed in or on a semiconductor wafer;

FIG. 2 conceptually illustrates a second exemplary embodiment of a semiconductor device;

FIG. 3 conceptually illustrates one exemplary embodiment of a method for selectively disabling portions of a cache memory; and

FIG. 4 conceptually illustrates one exemplary embodiment of a method for selectively enabling disabled portions of a cache memory.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

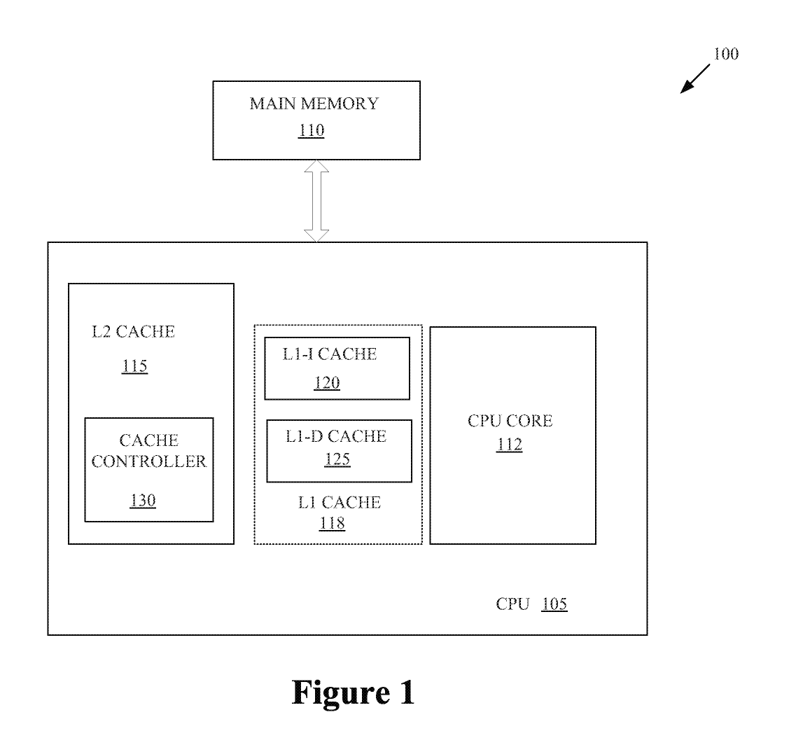

FIG. 1 conceptually illustrates a first exemplary embodiment of a semiconductor device 100 that may be formed in or on a semiconductor wafer (or die). The semiconductor device 100 may be formed in or on the semiconductor wafer using well known processes such as deposition, growth, photolithography, etching, planarising, polishing, annealing, and the like. In the illustrated embodiment, the device 100 includes a central processing unit (CPU) 105 that is configured to access instructions and/or data that are stored in the main memory 110. However, as will be appreciated by those of ordinary skill the art, the CPU 105 is intended to be illustrative and alternative embodiments may include other types of processor such as a graphics processing unit (GPU), a digital signal processor (DSP), an accelerated processing unit (APU), a co-processor, an applications processor, and the like in place of or in addition to the CPU 105. In the illustrated embodiment, the CPU 105 includes at least one CPU core 115 that is used to execute the instructions and/or manipulate the data. Alternatively, the processor-based system 100 may include multiple CPU cores 115 that work in concert with each other. The CPU 105 also implements a hierarchical (or multilevel) cache system that is used to speed access to the instructions and/or data by storing selected instructions and/or data in the caches. However, persons of ordinary skill in the art having benefit of the present disclosure should appreciate that alternative embodiments of the device 100 may implement different configurations of the CPU 105, such as configurations that use external caches. Moreover, the techniques described in the present application may be applied to other processors such as graphical processing units (GPUs), accelerated processing units (APUs), and the like.

The illustrated cache system includes a level 2 (L2) cache 115 for storing copies of instructions and/or data that are stored in the main memory 110. In the illustrated embodiment, the L2 cache 115 is 16-way associative to the main memory 105 so that each line in the main memory 105 can potentially be copied to and from 16 particular lines (which are conventionally referred to as “ways”) in the L2 cache 105. However, persons of ordinary skill in the art having benefit of the present disclosure should appreciate that alternative embodiments of the main memory 105 and/or the L2 cache 115 can be implemented using any associativity. Relative to the main memory 105, the L2 cache 115 may be implemented using smaller and faster memory elements. The L2 cache 115 may also be deployed logically and/or physically closer to the CPU core 112 (relative to the main memory 110) so that information may be exchanged between the CPU core 112 and the L2 cache 115 more rapidly and/or with less latency. For example, the physical size of each individual memory element in the main memory 110 may be smaller than the physical size of each individual memory element in the L2 cache 115, but the total number of elements (i.e. capacity) in the main memory 110 may be larger than the L2 cache 115. The reduced size of the individual memory elements (and consequent reduction in speed of each memory element) combined with the larger capacity increases the access latency for the main memory 110 relative to the L2 cache 115.

The illustrated cache system also includes an L1 cache 118 for storing copies of instructions and/or data that are stored in the main memory 110 and/or the L2 cache 115. Relative to the L2 cache 115, the L1 cache 118 may be implemented using smaller and faster memory elements so that information stored in the lines of the L1 cache 118 can be retrieved quickly by the CPU 105. The L1 cache 118 may also be deployed logically and/or physically closer to the CPU core 112 (relative to the main memory 110 and the L2 cache 115) so that information may be exchanged between the CPU core 112 and the L1 cache 118 more rapidly and/or with less latency (relative to communication with the main memory 110 and the L2 cache 115). In one embodiment, reduced size of the individual memory elements combined with larger capacity increases the access latency for the L2 cache 115 relative to the L1 cache 118. Persons of ordinary skill in the art having benefit of the present disclosure should appreciate that the L1 cache 118 and the L2 cache 115 represent one exemplary embodiment of a multi-level hierarchical cache memory system. Alternative embodiments may use different multilevel caches including elements such as L0 caches, L1 caches, L2 caches, L3 caches, and the like.

In the illustrated embodiment, the L1 cache 118 is separated into level 1 (L1) caches for storing instructions and data, which are referred to as the L1-I cache 120 and the L1-D cache 125. Separating or partitioning the L1 cache 118 into an L1-I cache 120 for storing only instructions and an L1-D cache 125 for storing only data may allow these caches to be deployed closer to the entities that are likely to request instructions and/or data, respectively. Consequently, this arrangement may reduce contention, wire delays, and generally decrease latency associated with instructions and data. In one embodiment, a replacement policy dictates that the lines in the L1-I cache 120 are replaced with instructions from the L2 cache 115 or main memory 110 and the lines in the L1-D cache 125 are replaced with data from the L2 cache 115 or main memory 110. However, persons of ordinary skill in the art should appreciate that alternative embodiments of the L1 cache 118 may not be partitioned into separate instruction-only and data-only caches 120, 125.

In operation, because of the low latency, the CPU 105 first checks the L1 caches 118, 120, 125 when it needs to retrieve or access an instruction or data. If the request to the L1 caches 118, 120, 125 misses, then the request may be directed to the L2 cache 115, which can be formed of a relatively larger total capacity but slower memory elements than the L1 caches 118, 120, 125. The main memory 110 is formed of memory elements that are slower but have greater total capacity than the L2 cache 115 and so the main memory 110 may be the object of a request when it receives cache misses from both the L1 caches 118, 120, 125 and the unified L2 cache 115. The caches 115, 118, 120, 125 can be flushed by writing back modified (or “dirty”) cache lines to the main memory 110 and invalidating other lines in the caches 115, 118, 120, 125. Cache flushing may be required for some instructions performed by the CPU 105, such as a write-back-invalidate (WBINVD) instruction.

A cache controller 130 is implemented in the CPU 105 to control and coordinate operation of the caches 115, 118, 120, 125. As discussed herein, different embodiments the cache controller 130 may be implemented in hardware, firmware, software, or any combination thereof. Moreover, the cache controller 130 may be implemented in other locations internal or external to the CPU 105. The cache controller 130 is electronically and/or communicatively coupled to the L2 cache 115, the L1 cache 118, and the CPU core 112. In some embodiments, other elements may intervene between the cache controller 130 and the caches 115, 118, 120, 125 without necessarily preventing these entities from being electronically and/or communicatively coupled as indicated. Moreover, in the interest of clarity, FIG. 1 does not show all of the electronic interconnections and/or communication pathways between the elements in the device 100. Persons of ordinary skill in the art having benefit of the present disclosure should appreciate that the elements in the device 100 may communicate and/or exchange electronic signals along numerous other pathways that are not shown in FIG. 1. For example, information may be exchanged directly between the main memory 110 and the L1 cache 118 so that lines can be written directly into and/or out of the L1 cache 118. The information may be exchanged over buses, bridges, or other interconnections.

Although there are many circumstances in which using the cache memories 115, 118, 120, 125 can improve performance of the device 100, in other circumstances caching provides little or no benefit. The cache controller 130 can therefore be used to disable portions of one or more of the cache memories 115, 118, 120, 125. In one embodiment, the cache controller 130 can disable a subset of lines in one or more of the cache memories 115, 118, 120, 125 to reduce power consumption during operation of CPU 105 and/or the cache memories 115, 118, 120, 125. For example, the cache controller 130 can selectively reduce the associativity of one or more of the cache memories 115, 118, 120, 125 to save power by either disabling clock signals to selected ways and/or by removing power to the selected ways of one or more of the cache memories 115, 118, 120, 125. A set of lines that is complementary to the disabled portions may continue to operate normally so that some caching operations can still be performed when the associativity of the cache has been reduced.

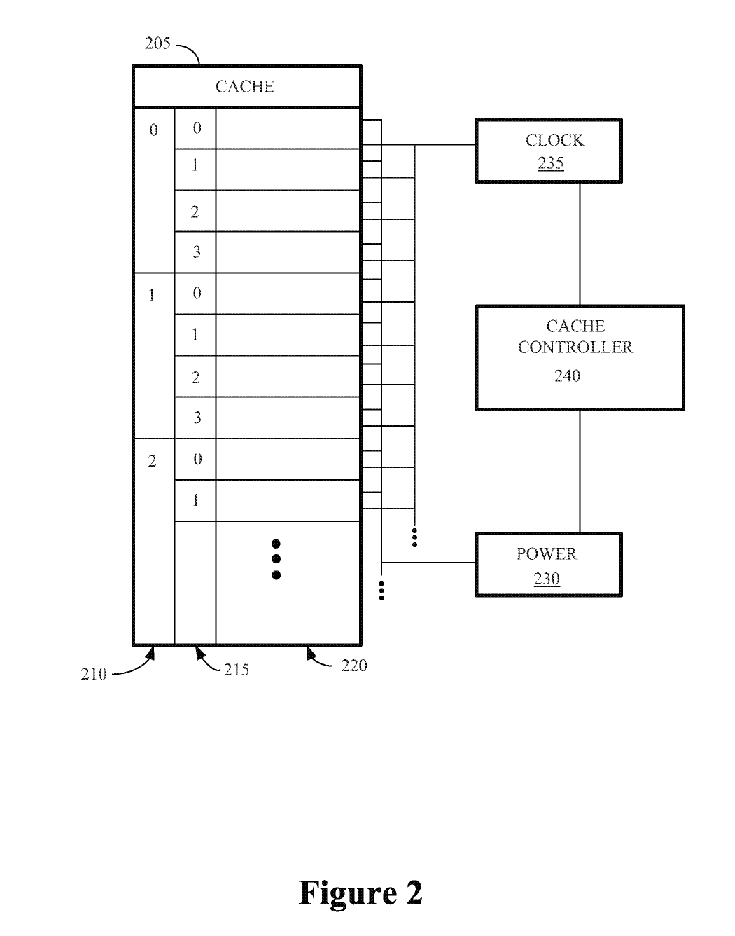

FIG. 2 conceptually illustrates a second exemplary embodiment of a semiconductor device 200. In the illustrated embodiment, the device 200 includes a cache 205 such as one of the cache memories 115, 118, 120, 125 depicted in FIG. 1. In the illustrated embodiment, the cache 205 is 4-way associative. The indexes are indicated in column 210 and the ways in the cache 205 are indicated by the numerals 0-3 in the column 215. The column 220 indicates the associated cache lines, which may include information and/or data depending on the type of cache. Persons of ordinary skill in the art having benefit of the present disclosure should appreciate that the associativity of the cache 205 is intended to be illustrative and alternative embodiments of the cache 205 may use different associativities. Power supply circuitry 225 can supply power selectively and independently to the different portions or ways of the cache 205. Clock circuitry 230 may supply clock signals selectively and independently to the different portions or ways of the cache 205.

A cache controller 240 is electronically and/or communicatively coupled to the power supply 230 and the clock 235. In the illustrated embodiment, the cache controller 240 is used to control and coordinate the operation of the cache 205, the power supply 230, and the clock circuitry 235. For example, the cache controller 240 can disable a selected subset of the ways (e.g., the ways 1 and 3) so that the associativity of the cache is reduced from 4-way to 2-way. Disabling the portions or ways of the cache 205 can be performed by selectively disabling the clock circuitry 235 that provides clock signals to the disabled portions or ways and/or selectively removing power from the disabled portions or ways. The remaining portions or ways of the cache 205 (which are complementary to the disabled portions or ways) remain enabled and receive clock signals and power. Embodiments of the cache controller 240 can be implemented in software, hardware, firmware, and/or combinations thereof. Depending on the implementation, different embodiments of the cache controller 240 may employ different techniques for determining whether portions of the cache 205 should be disabled and/or which portions or ways of the cache 205 should be disabled, e.g., by comparing the benefits of saving power by disabling portions of the cache 205 and the performance benefits of enabling some or all of the cache 205 for normal operation.

In one embodiment, the cache controller 240 performs control and coordination of the cache 205 using software. The software-implemented cache controller 240 may disable allocation to specific portions or ways of the cache 205. The software-implemented cache controller 240 can then either selectively flush cache entries for the portions/ways that are being disabled or do a WBINVD to flush the entire cache 205. Once the portions or ways of the cache 205 have been flushed and no longer contain valid cache lines, the software may issue commands instructing the clock circuitry 235 to selectively disable clock signals for the selected portions or ways of the cache 205. Alternatively, the software may issue commands instructing the power supply 230 to selectively remove or interrupt power for the selected portion or ways of the cache 205. In one embodiment, hardware (which may or may not be implemented in the cache controller 240) can be used to mask any spurious hits from disabled portions or ways of the cache 205 that may occur when the tag of an address coincidentally matches random information that remains in the disabled portions or ways of the cache 205. To re-enable the disabled portions or ways of the cache 205, the software may issue commands instructing the power supply 230 and/or the clock circuitry 235 to restore the clock signals and/or power to the disabled portions or ways of the cache 205. The cache controller 240 may also initialize the cache line state and enable allocation to the portions or ways of the cache 205.

Software used to disable portions of the cache 205 may implement features or functionality that allows the cache 205 to become visible to the application layer functionality of the software (e.g., a software application may access cache functionality through use of an interface or Application Layer Interface—API). Alternatively, the disabling software may be implemented at the operating system level so that the cache 205 is visible to the software.

In one alternative embodiment, portions of the cache controller 205 may be implemented in hardware that can process disable and enable sequences while the processor and/or processor core is actively executing. In one embodiment, the software controller 240 (or other entity) may implement software that can compare and contrast the relative benefits of power saving relative to performance, e.g., for a processor that utilizes the cache 205. The results of this comparison can be used to determine whether to disable or enable portions of the cache 205. For example, the software may provide signaling to instruct the hardware to power down (or disable clocks to) portions or ways of the cache 205 when the software determines that power saving is more important than performance. For another example, the software may provide signaling to instruct the hardware to power up (and/or enable clocks to) portions or ways of the cache 205 when the software determines that performance is more important than power.

In another alternative embodiment, the cache controller 240 may implement a control algorithm in hardware. The hardware algorithm can determine when portions or ways of the cache 205 should be powered up or down without software intervention. For example, after a RESET or a WBINVD of the cache 205, all ways of the cache 205 could be powered down. The hardware in the cache controller 240 can then selectively power up portions or ways of the cache 205 and leave complementary portions or ways of the cache 205 in a disabled state. For example, when an L2 cache sees one or more cache victims from an associated L1 cache, the L2 cache may determine that the L1 cache has exceeded its capacity and consequently the L2 cache may expect to receive data for storage. The L2 cache may therefore initiate the power up of some minimal subset of ways. The hardware may subsequently enable additional ways or portions of the cache 205 in response to other events, such as when a new cache line (e.g., from a north bridge fill from main memory or due to an L1 eviction) may exceed the current L2 cache capacity (i.e., the reduced capacity due to disabling of some ways or portions). Enabling additional portions or ways of the cache 205 may correspondingly reduce the size of the subset of disabled portions or ways, thereby increasing the capacity and/or associativity of the cache 205. In various embodiments, heuristics can also be employed to dynamically power up, power down, or otherwise disable and/or enable ways. For example, the hardware may implement a heuristic that disables portions or ways of the cache 205 in response to detecting low hit rate, a low access rate, a decrease in the hit rate or access rate, or other condition.

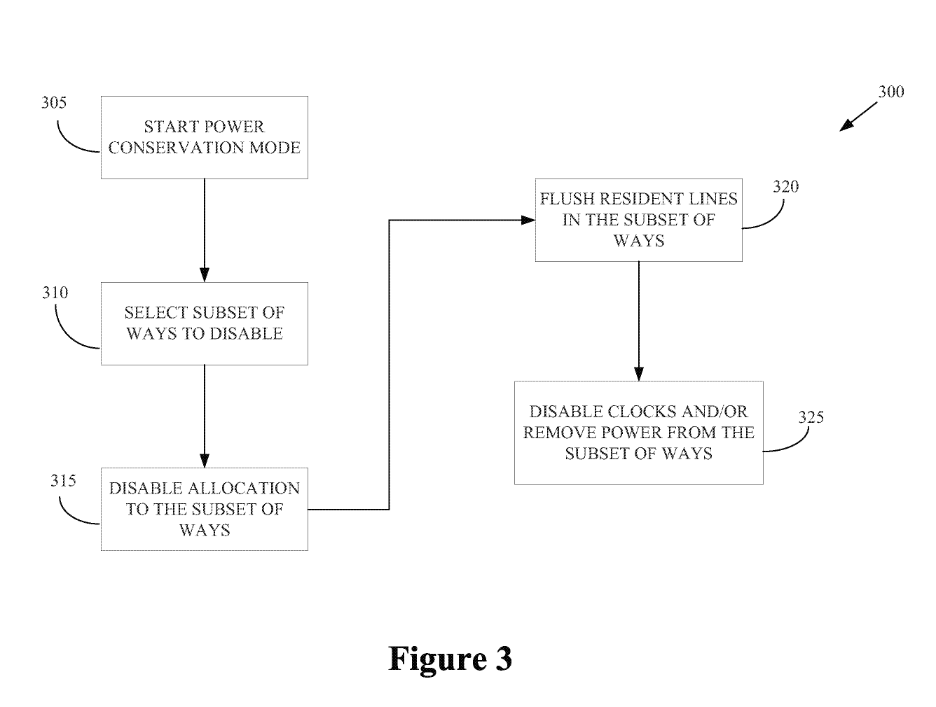

FIG. 3 conceptually illustrates one exemplary embodiment of a method 300 for selectively disabling portions of a cache memory. In the illustrated embodiment, the method 300 begins by detecting (at 305) the start of a power conservation mode. The power conservation mode may begin when a cache controller determines that conserving power is more important than performance. Commencement of the power conservation mode may indicate a transition from a normal operating mode to a power conservation mode or a transition from a first conservation mode (e.g., one that conserves less power relative to normal operation with a fully enabled cache) to a different conservation mode (e.g., one that conserves more power relative to normal operation and/or the first conservation mode.). A cache controller can then select (at 310) a subset of the ways of the cache to disable. The cache controller may disable (at 315) allocation of data or information to the subset of ways. Lines that are resident in the disabled ways may be flushed (at 320) after allocation to these ways has been disabled (at 315). The selected subset can then be disabled (at 325) using techniques such as powering down the selected subset of ways and/or disabling clocks that provide clock signals to the selected subset of ways.

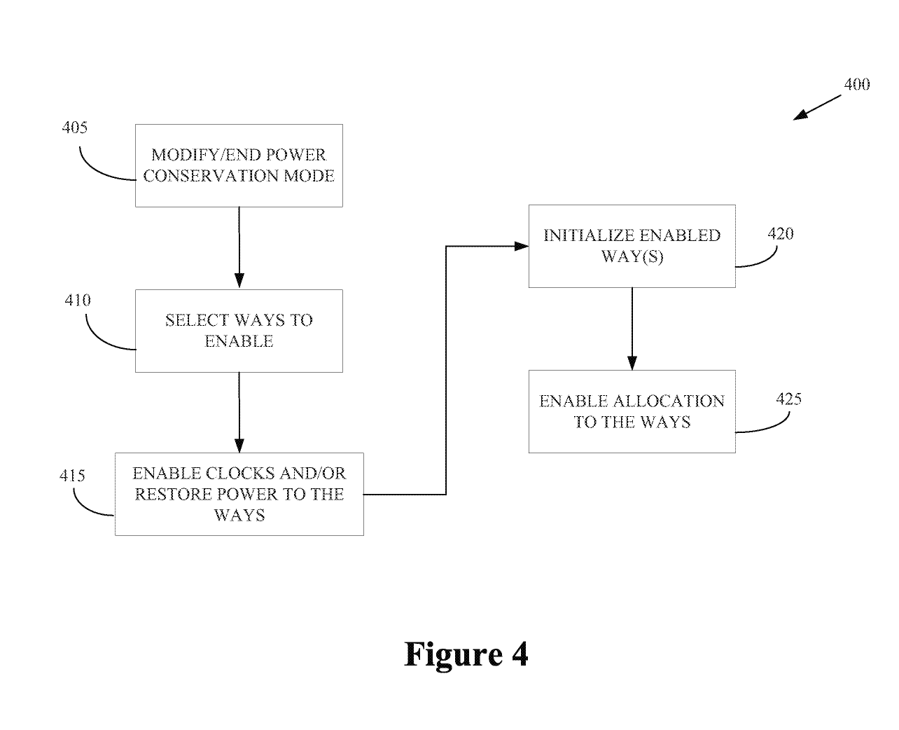

FIG. 4 conceptually illustrates one exemplary embodiment of a method 400 for selectively enabling disabled portions of a cache memory. In the illustrated embodiment, a method 400 begins by determining (at 405) that a power conservation mode is to be modified and/or ended. Modifying or ending the power conservation mode may indicate a transition from a power conservation mode to a normal operating mode that uses a fully enabled cache or a transition between power conservation modes that enable different sized portions of the cache or a different number of ways of the cache. A cache controller selects (at 410) one or more of the disabled ways to enable and then re-enables (at 415) the selected subset of the disabled ways, e.g., by enabling clocks that provide signals to the disabled ways and/or restoring power to the disabled ways. In one embodiment, the enabled ways can be initialized (at 420) via hardware or software. Alternatively, each memory cell can initialize (at 420) itself although the cost to do this is typically higher than the cost to initialize (at 420) the enabled ways using hardware or software. The cache controller can then enable (at 425) allocation of data or information to the re-enabled ways.

Embodiments of processor systems that implement dynamic power control of cache memory as described herein (such as the processor system 100) can be fabricated in semiconductor fabrication facilities according to various processor designs. In one embodiment, a processor design can be represented as code stored on a computer readable media. Exemplary codes that may be used to define and/or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
disabling a subset of lines in a cache memory to reduce power consumption during operation of the cache memory.

2. The method of claim 1, wherein disabling the subset of lines in the cache memory comprises at least one of disabling clocks for the subset of lines or removing power to the subset of lines.

3. The method of claim 1, wherein disabling the subset of lines in the cache memory comprises reducing an associativity of the cache memory by disabling a subset of the ways of the cache memory.

4. The method of claim 1, wherein disabling the subset of lines in the cache memory comprises flushing at least the subset of lines in the cache memory prior to disabling the subset of lines.

5. The method of claim 1, comprising masking spurious hits to the subset of lines following disabling of the subset of lines.

6. The method of claim 1, comprising enabling the subset of lines following disabling the subset of lines and enabling allocation of information to the subset of lines following enabling the subset of lines.

7. The method of claim 1, wherein disabling the subset of lines comprises selecting the subset of lines based on the relative importance of power saving and performance of the cache memory.

8. The method of claim 1, wherein disabling the subset of lines comprises disabling the subset of lines using hardware concurrently with active execution of a processor core associated with the cache memory.

9. The method of claim 8, wherein disabling the subset of lines using hardware comprises disabling all lines of the cache in response to powering down the processor core and subsequently enabling a second subset of lines that is complementary to the subset of lines.

10. The method of claim 9, wherein enabling the second subset of lines comprises enabling the second subset of lines in response to determining that capacity of the enabled lines of the cache has been exceeded.

11. The method of claim 8, wherein disabling the subset of lines using hardware comprises dynamically powering down a selected subset of ways of the cache using a heuristic based on at least one of a hit rate associated with the cache or an access rate associated with the cache.

12. The method of claim 1, wherein disabling the subset of lines comprises disabling the subset of lines in response to an instruction received by an application.

13. An apparatus, comprising:
means for disabling a subset of lines in a cache memory to reduce power consumption during operation of the cache memory.

14. An apparatus, comprising:
a cache controller configured to disable a subset of lines in a cache memory to reduce power consumption during operation of the cache memory.

15. The apparatus of claim 14, comprising the cache memory and at least one of a clock or a power source, and wherein the cache controller is configured to disable the subset of lines in the cache memory by disabling clocks for the subset of lines or removing power to the subset of lines.

16. The apparatus of claim 14, wherein the cache controller is configured to reduce an associativity of the cache memory by disabling a subset of the ways of the cache memory.

17. The apparatus of claim 14, wherein the cache controller is configured to flush at least the subset of lines in the cache memory prior to disabling the subset of lines.

18. The apparatus of claim 14, wherein the cache controller is configured to mask spurious hits to the subset of lines following disabling of the subset of lines.

19. The apparatus of claim 14, wherein the cache controller is configured to enable the subset of lines following disabling the subset of lines and wherein the cache controller is configured to enable allocation of information to the subset of lines following enabling the subset of lines.

20. The apparatus of claim 14, wherein the cache controller is configured to select the subset of lines based on the relative importance of power saving and performance of the cache memory.

21. The apparatus of claim 14, comprising a processor and hardware configured to disable the subset of lines concurrently with active execution of the processor.

22. The apparatus of claim 21, wherein the hardware is configured to disable all lines of the cache in response to powering down the processor and subsequently enable a second subset of lines that is complementary to the subset of lines.

23. The apparatus of claim 22, wherein the hardware is configured to enable the second subset of lines in response to determining that capacity of the enabled lines of the cache memory has been exceeded.

24. The apparatus of claim 21, wherein the hardware is configured to disable the subset of lines using hardware by dynamically powering down a selected subset of ways of the cache memory using a heuristic based on at least one of a hit rate associated with the cache or an access rate associated with the cache.

25. A computer readable media including instructions that when executed can configure a manufacturing process used to manufacture a semiconductor device comprising:
a cache controller configured to disable a subset of lines in a cache memory to reduce power consumption during operation of the cache memory.

26. The computer readable media set forth in claim 25, wherein the computer readable media is configured to store at least one of hardware description language instructions or an intermediate representation of the cache controller.

27. The computer readable media set forth in claim 26, wherein the instructions when executed configure generation of lithography masks used to manufacture the cache controller.
